(19) United States
(12) Patent Application Publication
(10) Pub. No.: US 2009/0196266 A1
(43) Pub. Date: Aug. 6, 2009

(54) Method and apparatuses for mobile communication

(75) Inventors: Yi Wu, Beijing (CN); Dong Mei Zhang, Beijing (CN)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 12/012,332

(22) Filed: Feb. 1, 2008

(51) Int. Cl. H04Q 7/24

(52) U.S. Cl. 370/338

(57) ABSTRACT

According to an embodiment, an apparatus such as a femto base station may include a transmitter to send via a local network an information to a mobile network for informing on an active state of apparatus. The apparatus may be configured to send the information when being switched on, or on a periodical or repeated basis in a switched-on state of the apparatus. A macro base station may add the femto base station to a network configuration list. Respective methods are also provided.

Femtocells are small, low-cost cellular base stations aiming at improving indoor coverage, and are seizing significant attention from mobile operators globally. Femtocells are small cellular access points That connect to a mobile operator's network using e.g. residential digital subscriber line, DSL, or cable broadband connections. The concept of femtocell is simple and aims at making a base station cheap enough to be deployed in high volume for residential use, and connecting such base stations to the core network via broadband. This will deliver a subscriber the same service and benefit as a converged offering but using existing standard handsets, with no need to upgrade to expensive dual-mode devices.

Femtocell base stations may improve cellular network access (e.g. 3G, WiMAX, LTE) reception in indoor environments such as shops in basements and in high-rise structures. Femtocell base stations may be a competitor e.g. to Wi-Fi in home access business.

However, considering a Femtocell scenario, in which a Femto base station is not included in a network configuration of a Macro base station, it may be difficult to detect the existence or distribution of Femto base stations or Femtocells. Since a Femto base station may be connected to a mobile core network by residential digital subscriber line, DSL, or cable broadband links, the distribution of Femto base stations is not as easily visible, from an O&M or RNC or ASN GW point of view, as those Macro base stations which are fixed according to a configurable network programming/design.

In such cases, a macro base station may not be aware of the existence of a Femto base station even if the Femto base station is connected to the mobile core network by residential DSL or cable broadband links. Furthermore, in case a Femto base station is e.g. made in plug-in style or may be switched on and off by a user at arbitrary timings, its site distribution in the network topology may be variable.

### SUMMARY

In accordance with one or more of embodiments of the invention, a method is provided, comprising sending, by an apparatus of a local network, an information to a mobile network for informing on an active state of the apparatus of the local network for generating or updating a network configuration list.

The apparatus may e.g. be a base station or Femto base station of the local network.

The apparatus of the local network may e.g. send the information when being switched on, or on a periodical or repeated basis in a switched-on state of the apparatus.

The apparatus of the local network may e.g., when starting up or at other active times, at least one of detect the existence of a base station of a mobile network, scans channel information of at least one base station, and measure channel information of at least one base station, in the coverage of which it is located in. The apparatus of the local network, after detection of at least one neighbouring base station of the mobile network, may send binding information to a mobile core network controller or the detected base station.

The method may e.g. comprise at least one, or any arbitrary combination, of:

synchronizing with the detected base station,

obtaining an identification of the base station of the mobile network,

obtaining at least one of time/frequency/channel information (e.g. preamble) of the base station of the mobile network, adjusting its time/frequency configuration for synchronization and reduction of interference with the base station of the mobile network based on at least one of response content and latency measured over a wired link,

sending a signalling message, which contains obtained information, to at least one of the detected base station, an operation and maintenance system, a radio network controller controlling the detected base station, the mobile network, a worldwide interoperability of microwave access, WiMAX, network, or a gateway,

the signalling message optionally containing an identification of the apparatus of the local network, or being sent through a residential network, digital subscriber line,. DSL, cable, broadband cable or other links provided at the local network,

updating a binding of the apparatus of the local network to the base station of the mobile network, on a periodical basis or at arbitrary times,

sending, when being normally shut down, an information notifying at least one of the binding base station and the mobile core network control over a wired link connected to the apparatus of local network, for detaching or updating a list of active base stations of the local network, or the network topology.

In accordance with one or more embodiments of the invention a method may comprise generating a valid binding of an apparatus of a local network to an apparatus of the mobile network by the apparatus of the mobile network after receiving a signalling message from the local network, or an operation and maintenance system or radio network controller or gateway. The apparatus of the mobile network may e.g. be a base station or Macro base station of the mobile network.

The method may comprise receiving the binding information includes a binding of the apparatus of the local base station to the apparatus of the mobile network in a network topology.

The method may e.g. comprise at least one of:

updating the network topology including the apparatus of the local network,

broadcasting the configuration over the mobile network,

updating a dynamic table which stores base station information on one or more base stations of the local network located within the coverage of a base station of the mobile network,

responding with its channel information to a base station of the local network,

updating a binding of the base station of the local network to the base station of the mobile network on a periodical or at defined or arbitrary times;

changing a network topology advertisement sent or broadcasted from the base station of the mobile network when detecting a break or shut down of the base station of the local network, or when receiving an information informing the local network on shut down of the base station of the local network.

The apparatus of the local network may e.g. be a base station or Femto base station.

In accordance with one or more embodiments of the invention, an apparatus may e.g. comprise a transmitter configured to send via the local network an information to a mobile network for informing on an active state of apparatus for generating or updating a network configuration list; a detector configured to detect the existence of an apparatus of a mobile network.

This apparatus of the local network may be a base station or a Femto base station of the local network, and the apparatus of the mobile network may be a base station or a macro base station.

The transmitter may be configured to send the information when being switched on, or on a periodical or repeated basis in a switched-on state of the apparatus.

The detector may be configured to, when starting up or at other active times, at least one of detecting the existence of a base station of a mobile network, scanning channel information of at least one base station, and measuring channel information of at least one base station, in the coverage of which it is located in. The apparatus may further comprise a processor configured to generate binding information and send the binding information to a mobile core network controller or the detected base station, wherein the binding information may include a binding of the apparatus to the detected apparatus of the mobile network in a network topology. The apparatus may be configured to send, after detection of at least one neighbouring base station of the mobile network, binding information to a mobile core network controller or the detected base station. The apparatus may be configured to, after detection of at least one neighbouring base station of the mobile network, at least one of:

synchronize with the detected base station,

obtain an identification of the base station of the mobile network,

obtain at least one of time/frequency/channel information (e.g. preamble) of the base station of the mobile network, adjust its time/frequency configuration for synchronization and reduction of interference with the base station of the mobile network based on at least one of response content and latency measured over a wired link,

send a signalling message, which contains obtained information, to at least one of the detected base station, an operation and maintenance system, a radio network controller controlling the detected base station, the mobile network, a worldwide interoperability of microwave access, WiMAX, network, or a gateway,

including into the signalling message optionally an identification of the apparatus,

send the signalling message through a residential network, digital subscriber line, DSL, cable, broadband cable or other links provided at the local network,

update a binding of the apparatus to the base station of the mobile network, on a periodical basis or at arbitrary times, send, when being normally shut down, an information notifying at least one of the binding base station and the mobile core network control over a wired link connected to the apparatus, for detaching or updating a list of active apparatuses of the local network, or the network topology.

According to another embodiment an apparatus may comprise a receiver configured to receive a signalling message from a local network, an operation and maintenance system, a radio network controller or a gateway, and a generator configured to generate or update a network configuration list of neighbouring base stations for handover. The network configuration list may comprise at least one of a base station of the mobile network,.and a base station of a local network. The generator may be configured to generate a valid binding of a base station of the local network to the apparatus. The apparatus may e.g. be a base station or a Macro base of a mobile network.

The apparatus may be configured to at least one of:

update a network topology including a base station of the local network,

broadcast the network topology advertisement over a mobile network,

update a dynamic table which stores base station information on one or more base stations of a local network located within the coverage of the apparatus,

respond with its channel information to the base station of the local network,

update a binding of the base station of the local network to the apparatus on a periodical or at defined or arbitrary times;

change a network topology advertisement sent or broadcasted from the apparatus when detecting a break or shut down of the base station of the local network, or when receiving an information informing on shut down of the base station of the local network.

In accordance with one or more embodiments, a system may comprise at least one first apparatus of a local network, being configured to send, via the local network, an information to a mobile network for informing on an active state of the first apparatus, and at least one second apparatus, configured to receive a signalling message from the local network, an operation and maintenance system, a radio network controller or a gateway, and to generate or update a network configuration list of neighbouring base stations for handover.

In the system, the information may include a binding of the first apparatus and the second apparatus. The system may be configured to detect by the first apparatus the existence of the second apparatus and to generate a binding of first apparatus and the second apparatus.

In accordance with one or more embodiments of the invention, a computer program product is provided which comprises code means configured to carry out or implement, when run on a processor, at least one or more of the methods mentioned above or in the following description.

In accordance with one or more embodiments of the invention, an apparatus may comprise means for sending via a local network an information to a mobile network for informing on an active state of the apparatus, for generating or updating a network configuration list; and means for detecting the existence of an apparatus of a mobile network.

In accordance with one or more embodiments of the invention, an apparatus may comprise means for receiving a signalling message from a local network, an operation and maintenance system, a radio network controller or a gateway; means for generating or updating a network configuration list of at least one neighbouring apparatus for handover.

According to an embodiment a method may comprise providing a network configuration list of neighbouring base stations for handover in a mobile network, the network configuration list including at least one base station of the mobile network, and at least one base station of a local network.

Embodiments of the invention allow the Macro base stations and the Femto base stations to be aware of each other, and the network topology and neighbour base station information can be updated so that a terminal such as a mobile station, MS, or user equipment is able to do scanning and pre-synchronization according to the neighbour advertisement from its serving base station, e.g. the Macro base station or Femto base station. In this way, a handover latency can be reduced in practice or actual use.

In accordance with one, more or all of the embodiments of the invention, at least one method, system, apparatus and computer program product are provided for neighbour list auto-update.

Further, in accordance with one, more or all of the embodiments of the invention, at least one method, system, apparatus and computer program product are provided for improving handover performance for macro and femto base stations.

Regarding Femtocells, embodiments are able to provide a seamless handover between Femto base stations and Macro base stations.

Embodiments of the invention provide handover solutions of Femto base station, BS.

A Macro base station, BS, may broadcast information about the network topology using e.g. a neighbour advertisement message. The message may provide channel information of neighbour base stations so that a mobile station can use the information for channel scanning and synchronization in handover preparation. In this way, the handover process can be expedited when the handover decision is made. In a practical example, the Macro base station may obtain the network topology and information of neighbour base stations through network configuration or network planning e.g. be collected by O&M, operations and maintenance, from some specific interface, or from a radio network controller, RNC, (for third generation, 3G, and LTE) or from a gateway of an access service network, ASN GW, for WiMAX.

The Femto base station may be connected to the mobile core network by residential DSL or cable broadband links.

A femto base station may use the same radio technology as a macro base station but has only restricted or low coverage area such as e.g. below 100 m diameter, e.g. about 50 m.

Embodiments of the invention provide a method and apparatus for neighbour list auto-update. Embodiments allow improving handover performance for macro and femto base stations.

Embodiments of the invention provide solutions for handover, including hand-in and hand-out wherein hand-in basically is more complex than hand-out. Here hand-in means mobile terminal, such as MS, handover from the Macro base station to the Femto base station, and hand-out means vice versa.

In the hand-in case, it may be difficult for the MS to decide whether it should do the handover unless its signal received from the Macro base station becomes weak enough because of e.g. the indoor environment. In the hand-out case, the handover is easier because of the short coverage of Femtocell and greater coverage of a macrocell. Whatever, when and how to do the frequency/channel scanning for the potential Femto base station can be decided based on received or detected related information e.g. obtained from the serving Macro or Femto base station.

In accordance with at least one or all of the embodiments of the invention, a computer program product is provided which comprises code means configured to carry out or implement, when run on a processor, a method as defined in any one of the claims or description. The computer program product may be embodied on a computer-readable medium.

Other objects, features and advantages of the invention will become apparent from the following description of embodiments of the invention.

### BRIEF DESCRIPTION OF DRAWINGS

FIG. 1 illustrates an embodiment of a system and apparatuses in accordance with the invention;

FIG. 2 shows an embodiment of a base station configured in accordance with an implementation of the invention;

FIG. 3 illustrates another embodiment of a base station configured in accordance with an implementation of the invention;

FIG. 4 shows an embodiment of a terminal configured in accordance with an implementation of the invention;

FIG. 5 shows an embodiment of a method in accordance with the invention; and

FIG. 6 illustrates another embodiment of a base station configured in accordance with an implementation of the invention.

### DESCRIPTION OF EMBODIMENTS

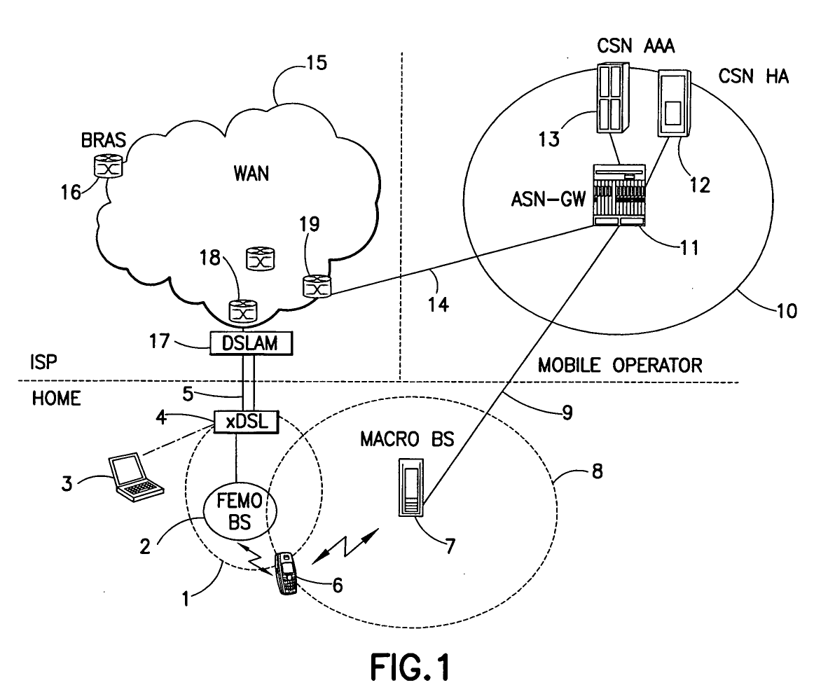

FIG. 1 illustrates an embodiment of a system and apparatuses in accordance with the invention. FIG. 1 shows Femto and Macro base stations, BS, in a WiMAX system with O&M, operations and maintenance.

The embodiment of FIG. 1 illustrates an embodiment of a network configuration. In this embodiment, at least one Femto base station 2 of a Femtocell 1, and at least one Macro base station 7 of a cell 8 of a mobile network are provided in a WiMAX system. Instead of WiMAX, LTE or other type of network may be used in embodiments. The embodiment of FIG. 1 comprises at least one or more Femtocells 1, one or more macrocells 8 of a mobile operator, a WiMax network 10, and optionally a wide area network, WAN, 15.

The Femtocell 1 includes the base station 2 which may be a Femto base station, allowing access to a DSL or cable or other type of network. As an example, a computer 3 may be connected by wireless access or in a wired manner to the digital subscriber line, DSL, or cable or other type of network. The radio coverage area of the Femto base station may define the area of the femtocell 1.

The Femtocell base station 2 may improve wideband code division multiple access, W-CDMA, reception in indoor environments such as shops in basements and in high-rise structures.

The Femtocell may also use other wireless broadband technologies such as WiMAX, worldwide interoperability for microwave access, and long-term evolution, LTE.

The Femto base station 2 may be located e.g. at a private home or an office in e.g. a SOHO, small home small office, environment. The Femto base station 2 may be connected by wire, cable or other type of connection, to an apparatus 4 which may e.g. be a router xDSL for a digital subscriber line, DSL. As shown by a dot-and-dash line, the computer 3 may alternatively or additionally also be connected by a wire or cable to the router 4 which itself is connected by a line, cable,-wire, DSL line, broadband cable or other type of connection 5 with the wide area network 15.

The macrocell 8 may be a normal cell of a mobile cellular network providing radio access between a terminal 6 and a base station 7 of the macrocell 8. The base station 7 may define the coverage area of the macrocell 8, and may be operating e.g. according to GSM, global system for mobile communication, UMTS, universal mobile telecommunications system, CDMA, code division multiple access, or other technologies. In the embodiment shown in FIG. 1, the macrocell 8 is at least partially overlapping with the femtocell 1.

The terminal 6 may e.g. be a mobile station MS or a user equipment UE, operating e.g. according to GSM, global system for mobile communication, UMTS, universal mobile telecommunications system, CDMA, code division multiple access, or other technologies.

The base station 7 is connected by a wire, wireless, cable or other connection 9 to an access services network gateway, ASN-GW, 11 of the WiMAX network 10. The. WiMAX network 10 further includes an home agent, CSN HA, 12 of a CSN, core services network, and an AAA, authentication, authorization, and accounting, device 13 of the CSN, core services network.

The access services network gateway, ASN-GW, 11 of the WiMAX network 10 is further connected by a wire, wireless, cable or other connection 14 to the wide area network 15 which comprises access points or access devices 16, 18, 19 such as gateways or routers etc.

The wide area network, WAN, 15 may e.g. be provided by an internet service provider, ISP. The access device 16 may allow access to a broadband radio access system, BRAS. The gateway or access point 18 is connected to a digital subscriber line access multiplexer, DSLAM, which is connected via the line 5 to the apparatus 4, e.g. a router xDSL for a digital subscriber line, DSL.

Although the term Femtocell is used here for describing a cell of small wireless or radio coverage area, the term Femtocell is not to be understood in a limiting sense but intends to cover all cells of different type providing a radio coverage or wireless access at a local basis, e.g. indoor or outdoor at a home or office or other type of a building or structure.

In the situation shown in FIG. 1, the terminal 6 is located at a border of the radio coverage of cell 8, has radio access to the cell 8 and, additionally, has radio access to the base station 2 of the cell 1, allowing handover from base station 7 to base station 2, or vice versa, depending on the movement direction of the terminal 6. The radio connection or access between the terminal 6 and the base stations 2, 7 is shown in FIG. 1 by curved double-headed arrows. In the situation shown in FIG. 1 at least one of the base stations 2, 7 and the terminal 6 may consider or initiate a handover of the terminal from the base station 7 to base station 2 or vice versa. The handover may also be of soft handoff type establishing a connection e.g. between the terminal 6 and the base station 2 while still maintaining the connection between the terminal 6 and the base station 7.

When the Femto base station 2 is e.g. a plug-in product for home or small office usage, a start-up and shut-down of the Femto base station 2 may frequently happen in a time scale of hours, days or weeks.

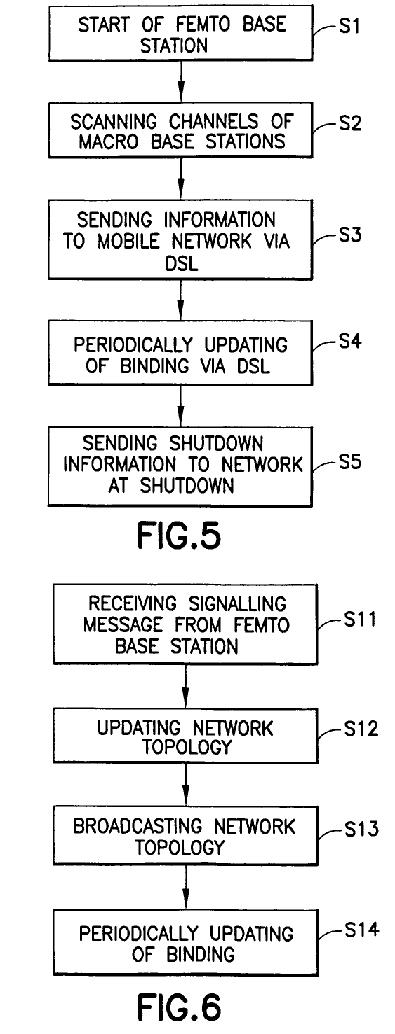

FIG. 5 illustrates an embodiment of a method which may be implemented in the base station 2 of the Femtocell 1. When the Femto base station 2 starts up as shown in step S1 of FIG. 5, it optionally first, or at some later time, works like a mobile terminal such as a MS, i.e. detects the existence of a Macro base station 7 providing radio access, e.g. by scanning a channel, e.g. the broadband channel of the base station 7. As shown in FIG. 1, the Femto base station 2 is located within the radio coverage area 8 of the base station 7 illustrated by the dotted line surrounding the base station 7.

When the Femto base station 2 detects the co-located base station 7, it may synchronize with the detected Macro base station 7. In this way, the Femto base station 2 can obtain an identification and also time/frequency/channel information (e.g. preamble) of the Macro base station 7. After that, the Femto base station 2 may send an e.g. predefined signalling message, which contains the obtained information, to at least one of the detected Macro base station 7 and to an O&M system or radio network controller, RNC, controlling the base station 7, or to the WiMAX network 10, e.g. to the gateway, ASN GW 11. The predefined message may contain an identification of the base station 2, and may be sent through the residential DSL 4, 5, 17, or cable, broadband cable or other links provided at the Femto cell 1, e.g. an air interface with the base station 7. The message containing the identification of the base station 2, and sent through the residential DSL 4, 5, 17, or cable, broadband cable or other links provided at the Femto cell 1, to the WAN 15 may be forwarded from the WAN 15 to the WiMax system 10 over link 14. The message containing the identification of the base station 2, may in another embodiment be directly sent from the base station 2 to the base station 7 and the cell 8, e.g. for transfer to the system 10 e.g. via an air interface between the base stations 2, 7.

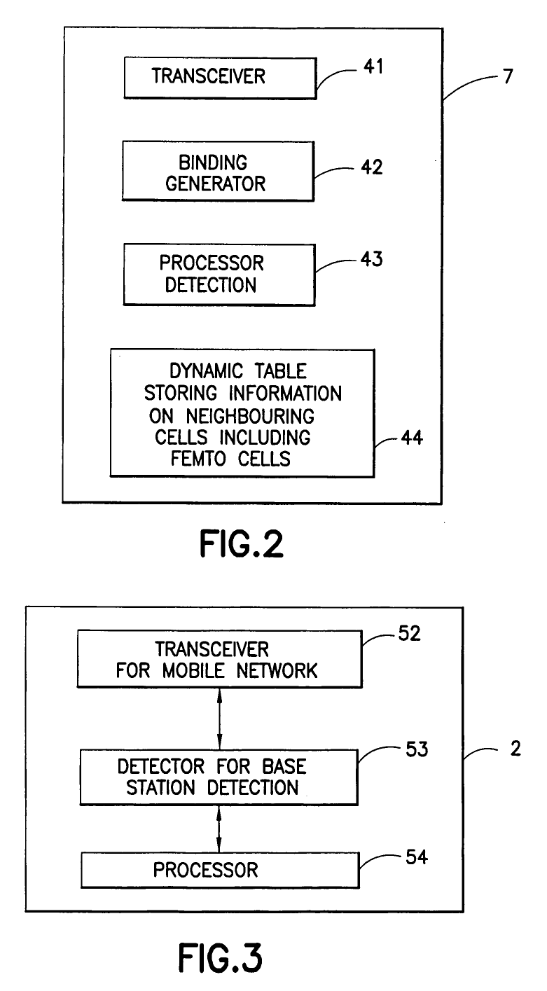

After receiving the signalling message, the Macro base station 7 or O&M system or RNC or ASN GW 11 may build a valid binding of the Femto base station 2 to the Macro base station 7. Therefore, the network topology including the Femto base station 2 can be updated and e.g. broadcasted over the network, e.g. via the base station 7. Accordingly, the Macro base station 7 may optionally update a dynamic table 44 shown in FIG. 2 which stores all the Femto base station information located within the coverage of the base station 7.

The Macro base station 7 optionally responds with its channel information to the Femto base station 2 so that the Femto base station 2 may adjust its time/frequency configuration for better synchronization and interference reducing with the Macro base station 7 based on the response content and latency measured over the wired link.

For the purpose of hand-in handover, the Macro base station 7 optionally periodically or at defined time points sends a message such as a neighbour BS advertisement which includes the information of all the Femto base stations within its coverage. During the idle or scanning mode if a terminal 6 such a mobile station, MS, detects a signal from a base station 2 belonging to the Femto base station list according to the advertisement of serving Macro base station 7 it may make a handover decision. The criteria for handover from Macro base station 7 to Femto base station 2 may e.g. be based on the network/channel condition or some other pre-defined terms. Such a handover is named here as hand-in handover.

For the purpose of hand-out handover, the Femto base station 2 may optionally provide the binding Macro base station information e.g. by neighbour advertisement message so that it may be easy for the terminal 6 to quickly handover to the Macro base station 7 at the edge of the Femtocell 1.

The valid binding of Femto base station 2 to Macro base station 7 may be e.g. periodically updated over the wired link 4, 5, or other information may be periodically or at defined or arbitrary times sent from the base station 2 over the wired link 4, 5 so that a break or shut down of the Femto base station 2 can be detected by one or more of the network 8, 10, 14 due to lack of such updates or sending of information at the expected times. When detecting a break or shut down, the network topology advertisement sent or broadcasted from the cell 8 can be changed accordingly. If the Femto base station 2 is normally shut down, it can optionally also actively notify at least one of the binding Macro base station 7 and the mobile core network control over the wired link 4, 5 for detaching or updating the list of active Femto base stations or the network topology.

A Femto base station 2 may thus optionally scan and measure the channel information of the one or more Macro base stations 7 in the coverage of which it is located in, e.g. during a start up process after activation such as switching-on of the Femto base station 2, or at some other time e.g. on a periodical basis or triggered by specified events. This feature is advantageous in view of the e.g. plug-in and site variable features of a Femto base station.

After that detection of one or more neighbouring macro base stations 7, the binding information may be sent by the Femto base station 2 e.g. over the wired link to the mobile core network controller and the related Macro base station 7. In this way, the binding of Femto base station 2 to the Macro base station 7 can be included in the network topology broadcasted by the serving base station.

The handover performance between Femtocell and Macrocell is therefore improved. Furthermore, the described embodiment of a configuration and method assists the Femto base station 2 in synchronization and interference reduction with the surrounding Macro base station 7.

FIG. 2 illustrates an embodiment of a Macro base station 7 implemented in accordance with one, more or all of the embodiments of the invention. The base station 7 includes a transceiver 41 for communication over an air interface with mobile terminals, e.g. 6, etc via broadcast and other channels, and also with the network; a binding generator 42 for generating and updating bindings to the Femto cells and other components; a processor 43 for detection of neighbouring base stations; and a dynamic table 44 stored in the base station 7 or cells. The dynamic table 44 stores information on neighbouring cells including femtocells 1 allowing handover to such neighbouring cells. The processor 43 provides at least one of functions and hardware structures for generating and updating the dynamic table 44 stored in the base station 7, e.g. when newly detecting an active Femtocell or base station, or when detecting a shutting-down of a previously active Femtocell. In case of an approaching or necessary handover, the table 44 may be checked for finding possible alternative cells for handover of an existing connection.

FIG. 3 illustrates an embodiment of a Femto base station 2 implemented in accordance with one, more or all of the embodiments of the invention. The Femto base station 2 includes a transceiver 52 for receiving signals or transmitting signals from or to the base station 7 via an air interface. The base station 2 further includes a detector 53 for base station detection. A processor 53 may provide communication, signals or decisions to be used for communication with the Femto or Macro cells.

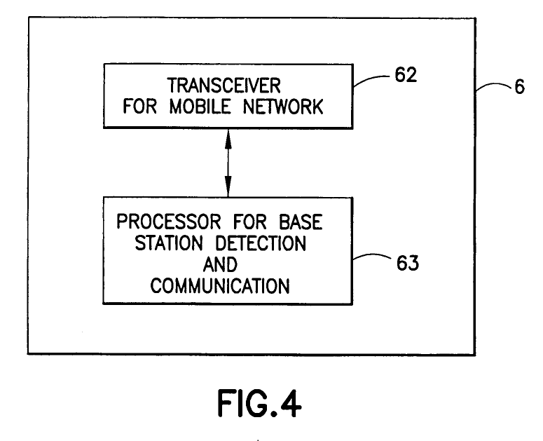

FIG. 4 illustrates an embodiment of a terminal 6 implemented in accordance with one, more or all of the embodiments of the invention. The terminal 6 includes a transceiver 62 for receiving signals or transmitting signals from or to the base station 7 via an air interface. The terminal 6 further includes a processor 63 for base station detection. The processor may 63 also provide communication, signals or decisions to be used for communication with the Femto or Macro cells.

FIG. 5 shows an embodiment of a method implemented in a base station such as Femto station 2, in accordance with an embodiment of the invention.

At a step S1, a Femto base station, e.g. base station 2, is started or activated. In a step S2, the Femto base station 2 scans channels so as to detect neighbouring Macro base stations. When detecting one or more neighbouring Macro base stations, the base station 2 sends respective information to the mobile network or an intermediate component via DSL or the like, as shown in step S3. In a step S4, the base station 2 updates the binding with the network so as to confirm continuing usability. Upon shutdown or switchoff of the Femto base station 2, the base station 2 may optionally sending a shutdown information to the network, as shown in step S5.

FIG. 6 shows an embodiment of a method implemented in a base station such as Macro station 7, in accordance with an embodiment of the invention. At a step S11, a Macro base station 7 receives one or more signalling messages from one or more Femto base stations 2. The base station 7 updates the network topology in a step S12, and broadcasts the detected network topology over e.g. a broadcast channel via the air, step S13. In a step S14, the binding may be periodically or at arbitrary times checked and updated so as to monitor the topology.

For supervising or controlling proper functioning of embodiments of the invention, the signalling process between the Femto base station 2 and the Macro base station 7 may be monitored.

For the purpose of the present invention as described herein above, it should be noted that any access or network technology may be used which may be any technology by means of which a user equipment can access a network. Any present or future technology, such as WLAN (Wireless Local Access Network), Cable networks, WiMAX (Worldwide Interoperability for Microwave Access), BlueTooth, Infrared, and the like may be used. The network may be any device, unit or means by which a mobile or stationary entity or other user equipment may connect to and/or utilize services offered by the network. Such services may include, among others, data and/or (audio-) visual communication, data download etc.

Generally, the present invention is also applicable in those network/terminal environments relying on a data packet based transmission scheme according to which data are transmitted in data packets and which are for example based on the Internet Protocol IP. The present invention is, however, not limited thereto, and any other present or future IP or mobile IP version, or, more generally, a protocol following similar principles is also applicable. The user equipment entity may be any device, unit or means by which a system user may experience services from a network.

The sequence of method steps described above or shown in the drawings can be implemented in any other sequence arbitrarily deviating from the above described or shown sequence of steps. The method steps may be implemented as software code portions and be run using a processor at a network element or terminal, can be software code independent, or can be specified using any known or future developed programming language as long as the functionality defined by the method steps is preserved. Generally, any method step is suitable to be implemented as software or by hardware without changing the idea of the present invention in terms of the functionality implemented. Method steps and/or devices, units or means may be implemented as hardware components at a mobile station or network element or module thereof, may be hardware independent, and can be implemented using any known or future developed hardware technology or any hybrids of these, such as MOS (Metal Oxide Semiconductor), CMOS. (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. Devices, units or means (e.g. User equipment, CSCF) can be implemented as individual devices, units or means, but may also be implemented in a distributed fashion throughout a system, as long as the functionality of the device, unit or means is preserved.

1. Method, comprising sending, by an apparatus of a local network, an information to a mobile network for informing on an active state of the apparatus of the local network for generating or updating a network configuration list.

2. Method according to claim 1, wherein the apparatus is a base station or Femto base station of the local network.

3. Method according to claim 1, wherein the apparatus of the local network sends the information when being switched on, or on a periodical or repeated basis in a switched-on state of the apparatus.

4. Method according to claim 1, wherein the apparatus of the local network, when starting up or at other active times, at least one of detects the existence of a base station of a mobile network, scans channel information of at least one base station, and measures channel information of at least one base station, in the coverage of which it is located in.

5. Method according to claim 4, wherein the apparatus of the local network, after detection of at least one neighbouring base station of the mobile network, sends binding information to a mobile core network controller or the detected base station.

6. Method according to claim 1, comprising at least one of:
synchronizing with the detected base station, obtaining an identification of the base station of the mobile network, obtaining at least one of time/frequency/channel information (e.g. preamble) of the base station of the mobile network, adjusting its time/frequency configuration for synchronization and reduction of interference with the base station of the mobile network based on at least one of response content and latency measured over a wired link.

7. Method according to claim 1, comprising at least one of:
sending a signalling message, which contains obtained information, to at least one of the detected base station, an operation and maintenance system, a radio network controller controlling the detected base station, the mobile network, a worldwide interoperability of microwave access, WiMAX, network, or a gateway, the signalling message optionally containing an identification of the apparatus of the local network, or being sent through a residential network, digital subscriber line, DSL, cable, broadband cable or other links provided at the local network,

8. Method according to claim 1, comprising at least one of:
updating a binding of the apparatus of the local network to the base station of the mobile network, on a periodical basis or at arbitrary times, sending, when being normally shut down, an information notifying at least one of the binding base station and the mobile core network control over a wired link connected to the apparatus of local network, for detaching or updating a list of active base stations of the local network, or the network topology.

9. Method, comprising
generating a valid binding of an apparatus of a local network to an apparatus of the mobile network by the apparatus of the mobile network after receiving a signalling message from the local network, or an operation and maintenance system or radio network controller or gateway.

10. Method according to claim 9, wherein the apparatus of the mobile network is a base station or Macro base station of the mobile network.

11. Method according to claim 9, comprising receiving the binding information includes a binding of the apparatus of the local base station to the apparatus of the mobile network in a network topology.

12. Method according to claim 9, comprising at least one of:
updating the network topology including the apparatus of the local network, broadcasting the configuration over the mobile network,
updating a dynamic table which stores base station information on one or more base stations of the local network located within the coverage of a base station of the mobile network,
responding with its channel information to a base station of the local network,
updating a binding of the base station of the local network to the base station of the mobile network on a periodical or at defined or arbitrary times;
changing a network topology advertisement sent or broadcasted from the base station of the mobile network when detecting a break or shut down of the base station of the local network, or when receiving an information informing the local network on shut down of the base station of the local network.

13. Method according to claim 9, wherein the apparatus of the local network is a Femto base station.

14. An apparatus, comprising
a transmitter configured to send via the local network an information to a mobile network for informing on an active state of apparatus for generating or updating a network configuration list;
a detector configured to detect the existence of an apparatus of a mobile network.

15. The apparatus according to claim 14, wherein the apparatus of the local network is a base station or a Femto base station of the local network, and the apparatus of a mobile network is a base station or a macro base station.

16. The apparatus according to claim 14, wherein transmitter configured to send the information when being switched on, or on a periodical or repeated basis in a switched-on state of the apparatus.

17. The apparatus according to claim 14, wherein the detector, when the apparatus starting up or at other active times, is configured to at least one of detecting the existence of a base station of a mobile network, scanning channel information of at least one base station, and measuring channel information of at least one base station, in the coverage of which it is located in.

18. The apparatus according to claim 14, wherein the apparatus further comprises a processor configured to generate binding information and send the binding information to a mobile core network controller or the detected base station, where in the binding information includes a binding of the apparatus to the detected apparatus of the mobile network in a network topology.

19. The apparatus according to claim 14, wherein the apparatus is configured to, after detection of at least one neighbouring base station of the mobile network, at least one of:
synchronize with the detected base station,
obtain an identification of the base station of the mobile network,
obtain at least one of time/frequency/channel information (e.g. preamble) of the base station of the mobile network,
adjust its time/frequency configuration for synchronization and reduction of interference with the base station of the mobile network based on at least one of response content and latency measured over a wired link,
send a signalling message, which contains obtained information, to at least one of the detected base station, an operation and maintenance system, a radio network controller controlling the detected base station, the mobile network, a worldwide interoperability of microwave access, WiMAX, network, or a gateway,
including into the signalling message optionally an identification of the apparatus, send the signalling message through a residential network, digital subscriber line, DSL, cable, broadband cable or other links provided at the local network,
update a binding of the apparatus to the base station of the mobile network, on a periodical basis or at arbitrary times,
send, when being normally shut down, an information notifying at least one of the binding base station and the mobile core network control over a wired link connected to the apparatus, for detaching or updating a list of active apparatuses of the local network, or the network topology.

20. An apparatus, comprising:
a receiver configured to receive a signalling message from a local network, an operation and maintenance system, a radio network controller or a gateway;
a generator configured to generate or update a network configuration list of at least one neighbouring apparatus for handover.

21. The apparatus according to claim 20, wherein the network configuration list comprises at least one of a base station of the mobile network, and a base station of a local network.

22. The apparatus according to claim 20, wherein the generator is configured to generate a valid binding of a base station of the local network to the apparatus.

23. The apparatus according to claim 20, wherein the apparatus is a base station or a Macro base of a mobile network.

24. The apparatus according to claim 20, wherein the apparatus is configured to at least one of:
update a network topology including a base station of the local network, broadcast the network topology advertisement over a mobile network,
update a dynamic table which stores base station information on one or more base stations of a local network located within the coverage of the apparatus,
respond with its channel information to the base station of the local network,
update a binding of the base station of the local network to the apparatus on a periodical or at defined or arbitrary times;
change a network topology advertisement sent or broadcasted from the apparatus when detecting a break or shut down of the base station of the local network, or
when receiving an information informing on shut down of the base station of the local network.

25. A system comprising
at least one first apparatus of a local network, being configured to send, via the local network, an information to a mobile network for informing on an active state of the first apparatus, and
at least one second apparatus, configured to receive a signalling message from the local network, an operation and maintenance system, a radio network controller or a gateway, and to generate or update a network configuration list of at least one neighbouring apparatus for handover.

26. A system according to claim 25, wherein the information includes a binding of the first apparatus and the second apparatus.

27. A system according to claim 25, being configured to detect by the first apparatus the existence of the second apparatus and to generate a binding of first apparatus and the second apparatus.

28. Computer program product, comprising code means configured to carry out or implement, when run on a processor, a method in accordance with claim 1.

29. An apparatus, comprising
means for sending via a local network an information to a mobile network for informing on an active state of the apparatus, for generating or updating a network configuration list; and
means for detecting the existence of an apparatus of a mobile network.

30. An apparatus, comprising:
means for receiving a signalling message from a local network, an operation and maintenance system, a radio network controller or a gateway;
means for generating or updating a network configuration list of at least one neighbouring apparatus for handover.

31. Computer program product, comprising code means configured to carry out or implement, when run on a processor, a method in accordance with claim 9.
